(19) United States
(12) Patent Application Publication
(10) Pub. No.: US 2026/0364869 A1
(43) Pub. Date: Nov. 19, 2026

(54) DEVICE FOR THE TEMPORARY STORAGE OF CONTAINERS

(71) Applicant: ACMI BEVERAGE S.P.A., Sorbolo (Parma) (IT)

(72) Inventors: Alessandro PAINI, PARMA (IT); Mirco MASSARI, PARMA (IT)

(21) Appl. No.: 19/155,351

(22) PCT Filed: Feb. 15, 2024
(86) PCT No.: PCT/IB2024/051433

§ 371 Date: Aug. 11, 2025

(30) Foreign Application Priority Data
Feb. 17, 2023 (IT) 102023000002703

(51) Int. Cl. B29C 49/42; B29L 31/00; B65G 29/00; B65G 60/00; B67C 3/22

(52) U.S. Cl. CPC B29C 49/42107; B29C 49/4207; B65G 29/00; B65G 60/00; B29L 2031/7158; B65G 2201/0244; B67C 2003/227

(57) ABSTRACT

A device for the temporary storage of containers, which includes at least one feeder conveyor of containers and at least one unloading conveyor of the containers further including a storage unit with a number of accommodation bodies which extend substantially parallel to each other along a substantially vertical direction of extension and are each configured to accommodate a number of containers stacked on top of each other with their longitudinal axis of extension arranged parallel to the direction of extension of the respective accommodation body.

### CROSS-REFERENCE TO RELATED APPLICATIONS

This application is a 35 U.S.C. § 371 National Stage patent application of PCT/IB2024/051433 filed 15 Feb. 2024, which claims the benefit of Italian patent application 102023000002703, filed on 17 Feb. 2023, the disclosures of which are incorporated herein by reference in their entirety.

### TECHNICAL FIELD

The present disclosure relates to a device for the temporary storage of containers.

### BACKGROUND

In systems for processing containers, and in particular in systems that include the blow-molding, filling (typically with a beverage), capping and labeling of containers, it is often necessary to have buffers where the containers can be stored temporarily, for example in the event of malfunctions or of stoppages/shutdowns of the system. Such buffers are required in particular in those types of system which have, upstream of a filling machine, a machine for producing containers, for example a blow-molding machine for producing plastic containers starting from preforms by means of blow molding.

In case of malfunctions or of stoppages of the filling machine, or of a machine downstream of the filling machine, such as a cap applicator, a labeling unit or a shrink-wrap machine, it is necessary to be able to store the containers produced by the blow-molding machine, starting from the already-heated preforms, in a buffer in order to prevent them from being discarded.

Typically, intermediate storage units are therefore provided which are constituted by variable-speed accumulator mats which have an inlet, typically constituted by conveyor belts, connected to a conveyor originating from for example the blow-molding unit, and an outlet connected to the filling machine.

A disadvantage of the known storage units is their considerable bulk and, as a consequence, the need to allocate a considerable space in the environment where the system is installed in order to ensure a sufficient storage capacity.

Other drawbacks of the solutions known today are the following:
buffering the containers at random means that individual containers cannot be tracked along the system;
in some cases the various containers sent to the intermediate storage units generate a pushing action if there are accumulator storage units with a large number of containers, and this pushing can cause damage to the containers;
during the conveying step, the containers are unstable and, as a consequence, it is possible for them to fall and for the system to stop as a consequence;
a certain variability is found in the behavior of the system as a function of the environmental conditions, the end effect of which is to vary the friction coefficient of the conveyor belts.

### SUMMARY

The aim of the present disclosure is to provide a device for the temporary storage of containers which is capable of improving the known art in one or more of the above-mentioned aspects.

Within this aim, the disclosure provides a device for the temporary storage of containers which is characterized by reduced bulk.

Another feature of the disclosure is to provide a device for the temporary storage of containers which is highly reliable, easy to implement and at low cost.

This aim and these and other advantages which will become better apparent hereinafter are achieved by providing a device for the temporary storage of containers according to the independent claim, optionally provided with one or more of the characteristics of the dependent claims.

### BRIEF DESCRIPTION OF THE DRAWINGS

Further characteristics and advantages of the disclosure will become more apparent from the description of some preferred, but not exclusive, embodiments of the device for the temporary storage of containers according to the disclosure, which are illustrated for the purposes of non-limiting example in the accompanying drawings wherein:

FIG. 1 is a schematic view from above of the device for the temporary storage of containers according to the disclosure;

FIG. 2 is a cross-sectional view of the device according to the disclosure taken along the plane of arrangement identified by the line II-II of FIG. 1;

FIG. 3 is a schematic view from above of the device according to the disclosure;

FIG. 4 is a perspective view of the flow of containers fed to the temporary storage device;

FIG. 5 is a perspective schematic view of the storage unit;

FIG. 6 is a side view of the storage unit;

FIG. 7 is a perspective view, from a first viewpoint, of a further embodiment of the device according to the disclosure in which, for greater clarity, only one accommodation body is shown;

FIG. 8 is another perspective view, from another viewpoint, of the embodiment of the device shown in FIG. 7; and

FIG. 9 shows a storage unit presenting the embodiment of FIGS. 7 and 8.

### DETAILED DESCRIPTION OF THE DRAWINGS

With reference to the figures, the device for the temporary storage of containers according to the disclosure, generally designated by the reference numeral 1, comprises at least one feeder conveyor 2 of containers 10 and at least one unloading conveyor 3 of the containers 10.

The device 1 comprises a storage unit 11 comprising a plurality of accommodation bodies 11a which extend substantially parallel to each other along a substantially vertical direction of extension 100 and are each configured to accommodate a plurality of containers 10 stacked on top of each other with their longitudinal axis of extension 101 arranged parallel to the direction of extension 100 of the respective accommodation body 11a.

Advantageously, the device 1 comprises means for movement on command 20 of the containers 10 along the direction of extension 100.

In particular, the means for movement on command 20 are adapted to move the containers 10 arriving from the feeder conveyor 2 from a first elevation to a second elevation along the direction of extension 100.

In particular, the means for movement on command 20 are configured to act when placed under the bottom of the respective containers 10 during the transition from the first elevation to the second elevation.

Advantageously, the containers 10 comprise containers 10 that are already filled.

The fact that the means for movement on command 20 define a resting surface for the bottom of the respective container 10 in fact makes it possible to store and manage a container of a certain weight, such as the containers 10 after they are filled and capped, while a movement acting on other portions would in any case be difficult and unreliable. Means for temporary locking 30 of the container 10 at the second elevation are furthermore provided.

According to a preferred embodiment, the accommodation bodies 11a are arranged at the peripheral region of a carousel 12 and can rotate on command about the axis 103 of the carousel 12.

The axis 103 of the carousel is, in particular, arranged substantially parallel to the directions of extension 100.

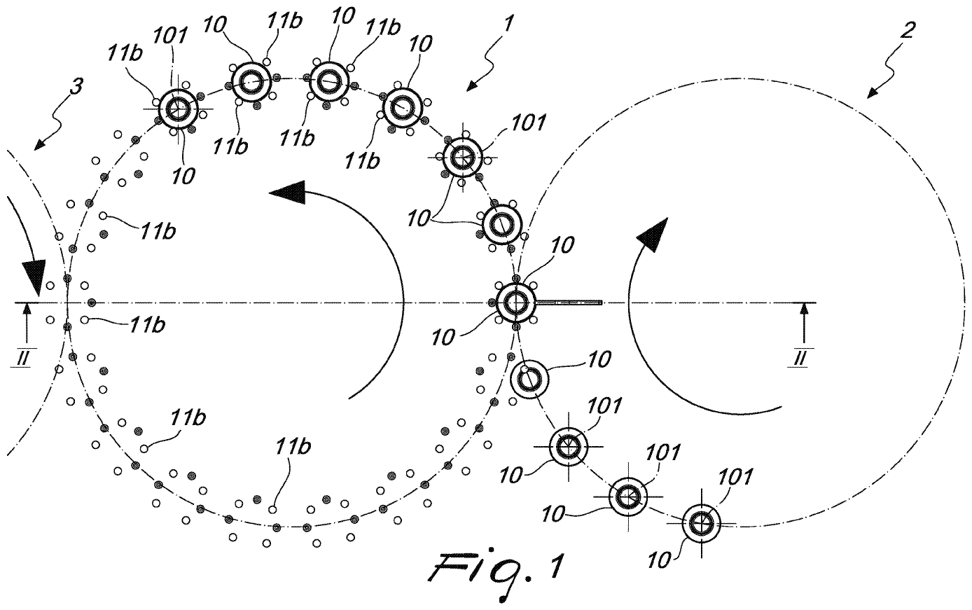

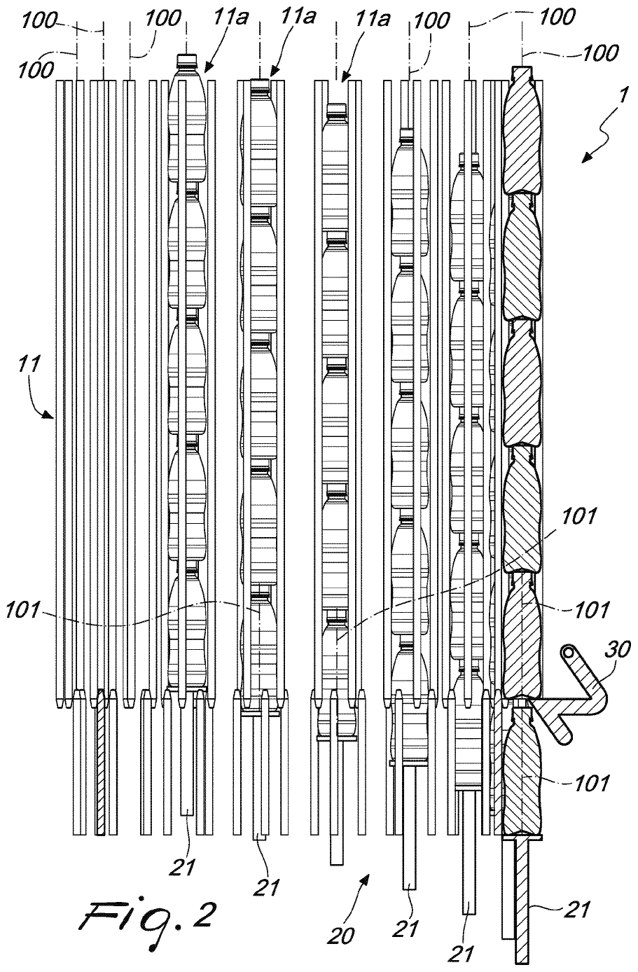

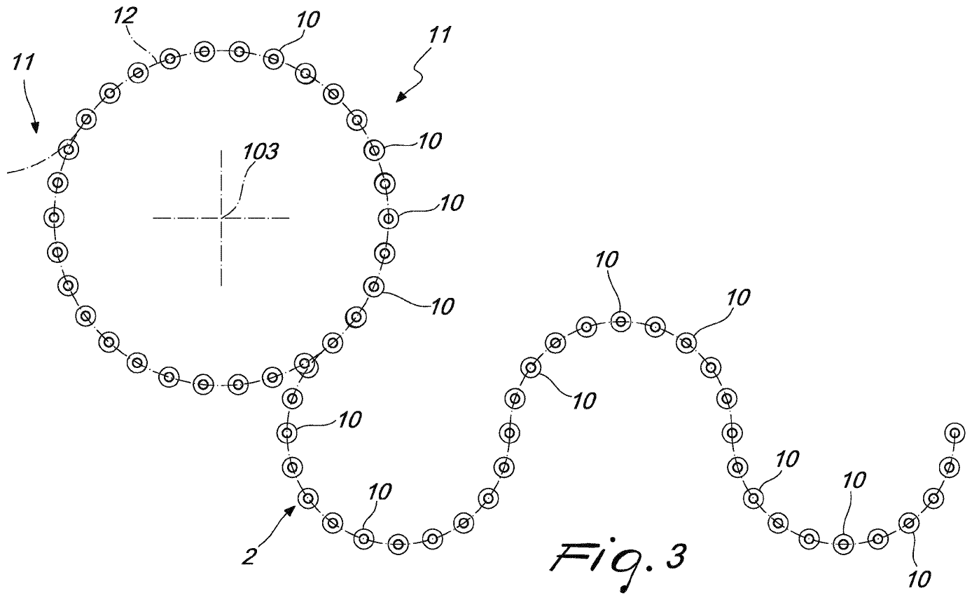

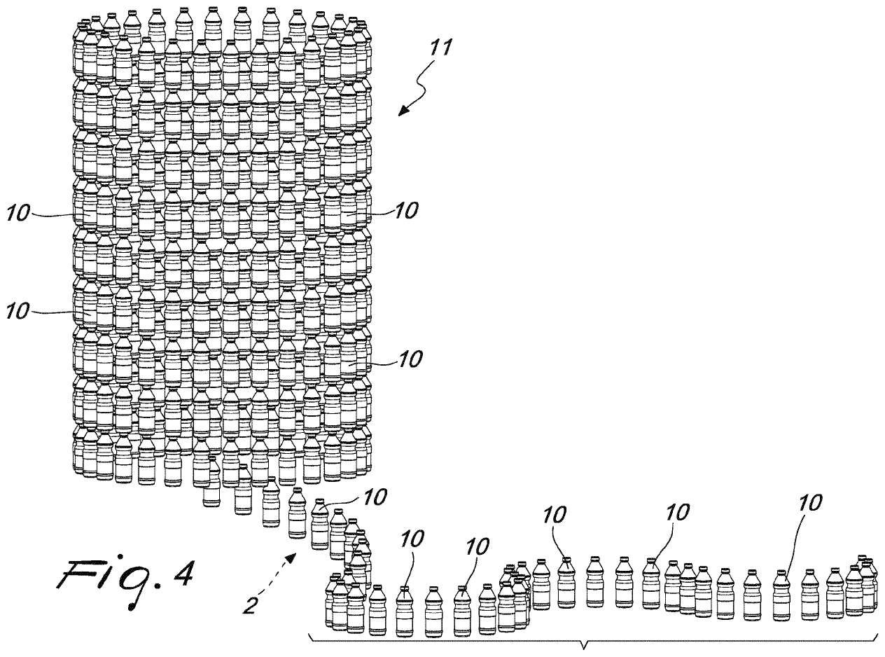

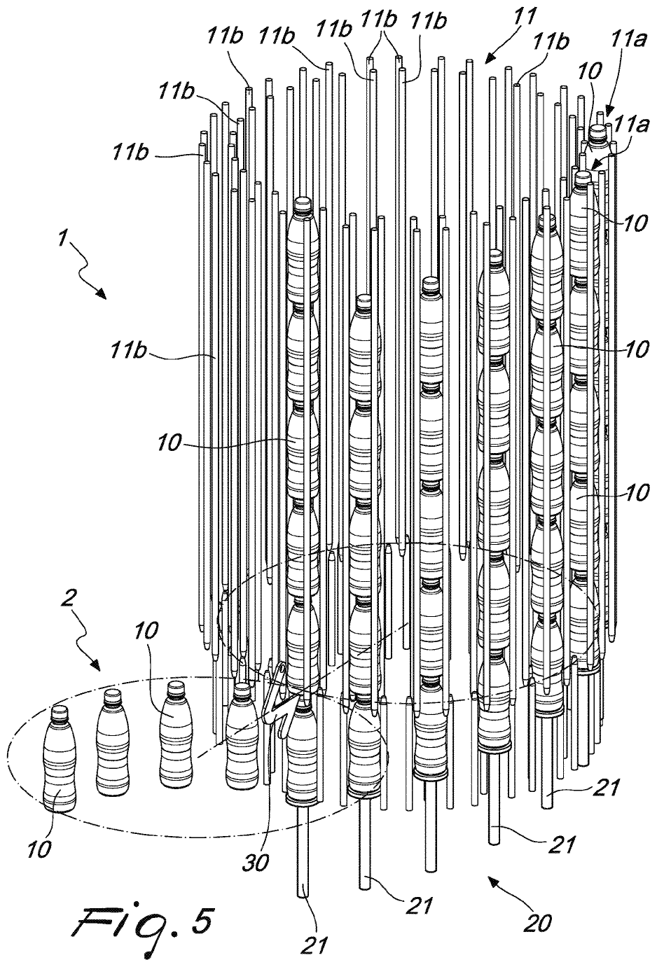

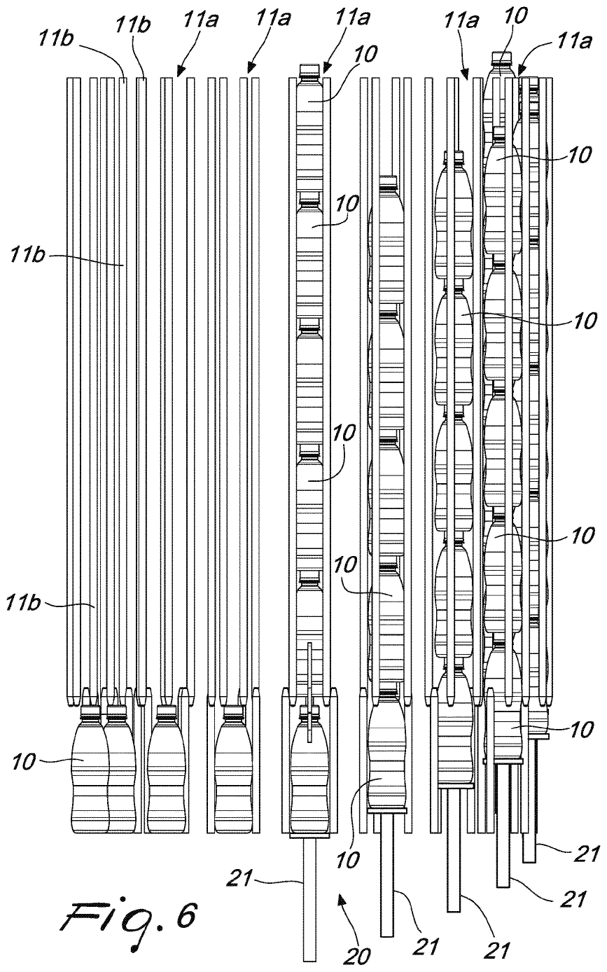

With reference to the embodiment shown in FIGS. 1 to 6, the means for movement 20 comprise a movement pan 21 which is arranged below a respective accommodation body 11a and can be moved on command along a vertical direction in order to bring a respective container arriving from the feeder conveyor 2 from the first elevation to the second elevation.

In particular, the second elevation is arranged above the first elevation. The means for temporary locking 30 are substantially arranged at the second elevation and are configured to retain the container 10 at the second elevation when the pan 21 is brought back to the lowered condition so that it can then lift another container 10.

The means for temporary locking 30 are functionally associated with actuation means adapted to allow their transition from an active condition, in which they retain the container 10 at the second elevation, to an inactive condition, in which they disengage from the container 10 to allow the latter to be unloaded from the storage unit 11.

With reference to the embodiment shown in FIGS. 1 to 6, the containers 10 arranged at each accommodation body 11a and arranged above the container at the second elevation are supported directly by the container 10 that is arranged directly below.

This makes it possible to simplify the storage unit 11 by using a single movement device (the pan 21) and a single means of temporary retention 30 for managing the stacking and unstacking of a plurality of containers 10.

The means for temporary locking 30 are furthermore adapted to pass from the active condition to the inactive condition in order to allow the transfer of the container 10 from the first elevation to the second elevation.

It is possible for example that this passage is determined directly by lifting the arriving container 10, or independent actuation means can be provided.

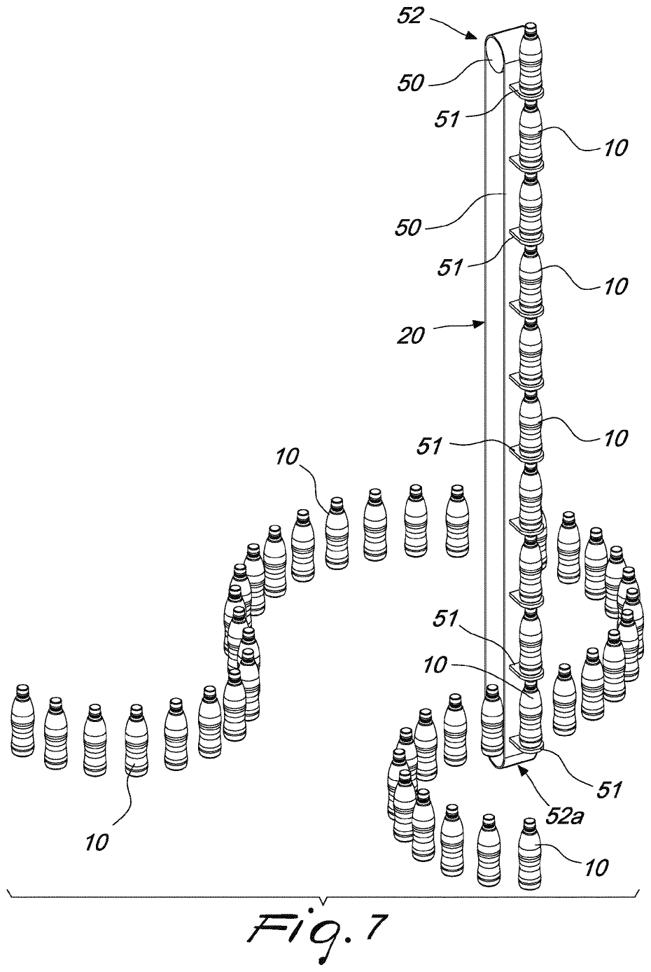

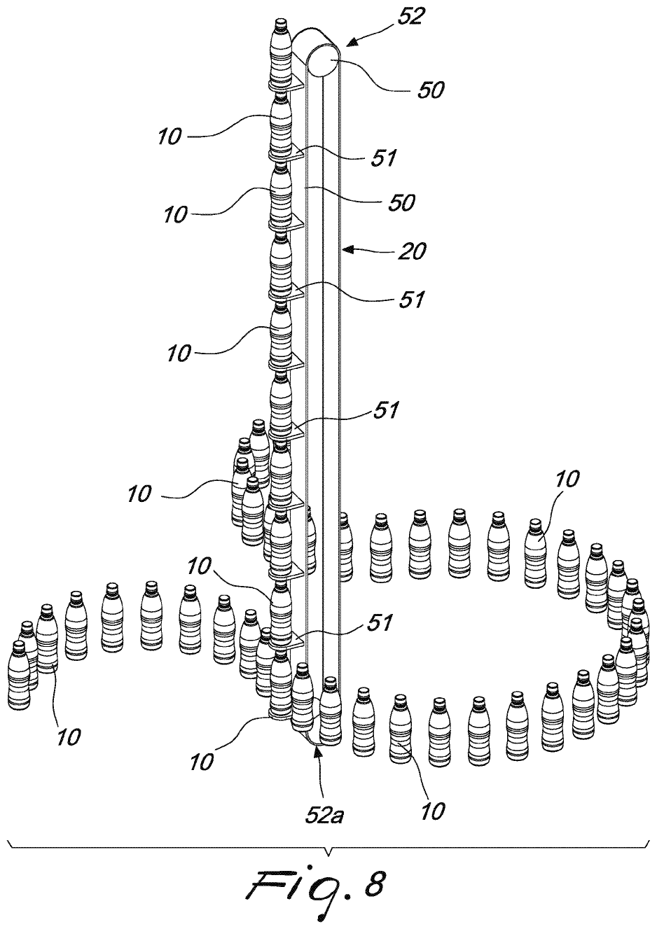

With reference to the embodiment shown in FIGS. 7 and 8, the means for movement on command 20 comprise, at each accommodation body 11a, at least one elongated element 50 which extends substantially parallel to the direction of extension 100.

The elongated element 50 is associated with a plurality of supporting bodies 51 which are spaced apart from each other along the direction of extension 100 and are designed to define a resting surface for the bottom of a respective container 10.

The means for movement on command 20 are, in particular, adapted to move on command the supporting bodies 51 along the direction of extension 100.

Preferably, the elongated element 50 is wound around at least one movement pulley 52 which is kinematically connected to actuation means.

More conveniently, the elongated element 50 has a closed extension and is wound around a lower pulley 52a and around an upper pulley 52b.

Motor means act, for example, on one of the two pulleys 52, in one direction of rotation or in the opposite direction, to move the supporting bodies 51 upward or downward along the direction of extension 100. In order to allow the storage of containers 10 of different transverse dimensions, it is possible for the device 1 to comprise means for adjusting the transverse dimensions of the accommodation bodies 11a.

For example the device could have sets of accommodation bodies 11a of different transverse dimensions, which can be selectively associated with the storage unit 11.

Alternatively, the accommodation bodies 11a could comprise a plurality of elongated elements 11b which extend parallel to the direction of extension 100.

In this case, the means for adjusting the transverse dimensions of the accommodation bodies 11a comprise means for the radial movement of the elongated elements 11b.

According to a further aspect, the present disclosure relates to a system for processing containers 10 which comprises an apparatus for the production of plastic containers by means of blow molding preforms of plastic.

The system comprises, downstream of the apparatus for the production of the containers 10, at least one device 1 for the temporary storage of the containers 10 which has the characteristics described above.

Conveniently, the system comprises, downstream of the apparatus for the production of the containers 10, at least one apparatus for filling and capping the containers: the device 1 is, in particular, arranged downstream of the filling and capping apparatus.

Preferably, the system comprises an apparatus for labeling the containers.

In this case, the device 1 is arranged upstream of the labeling apparatus.

The various apparatuses of the system are functionally connected, so that the blow-molded containers are normally immediately filled, capped and then labeled.

The operation of the device 1 for the temporary storage of containers 10 according to the disclosure is the following.

The containers produced by the apparatus for the production of containers are sent to the filling and capping apparatus and then, once filled and capped, to the feeder conveyor 2.

If all the machines in the system function correctly, the feeder conveyor 2 brings the containers 10 to the peripheral region of the carousel 12 and, in particular, to the pans 21, or alternatively to the supporting bodies 51 which, by moving along the peripheral region of the carousel about the axis 103, without performing any vertical movement, take the containers 10 directly to the unloading conveyor 3.

In some cases it is possible to also have a vertical movement of the pans between the feeder conveyor 2 and the unloading conveyor 3, during the regular flow of the containers 10, for example in order to compensate the difference in height of the different bottle formats.

If some apparatuses downstream of the storage unit 11 experience a malfunction, it is possible to buffer the containers 10 arriving from the feeder conveyor 2, stacked on each other at the accommodation bodies 11a defined above the pans 21 or generally above the elevation of advancement of the containers 10.

In this case, the pans 21, or the supporting bodies 51, while they rotate about the axis 103 of the carousel 12, are lifted in order to bring the containers 10 from the first elevation to the second elevation. Once it has reached the second elevation, the container can be retained by the means for temporary locking 30.

In this manner, the pan 21 can be lowered in order to return to the first elevation and receive a new container 10 arriving from the feeder conveyor 2 and lift it toward the second elevation as well.

With its top, this container 10 exerts an upward thrust on the container 10 that is temporarily at the second elevation, and so on.

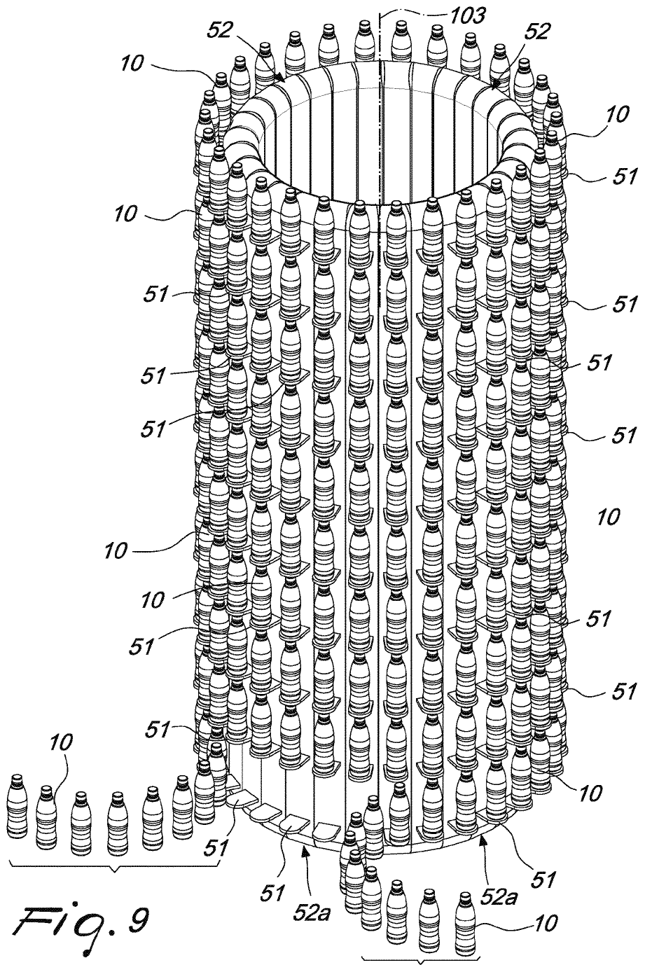

In the embodiment shown in FIGS. 7 to 9, the means for temporary locking 30 are provided by the supporting bodies 51, which retain and support, from below, the containers 10 arranged one on top of the other.

The storage unit 11 thus structured is extremely compact and presents reduced bulk, making it possible in any case to store a number of containers 10 substantially corresponding to the number of the preforms contained in the conditioning oven and therefore preventing the discarding of containers produced on systems that involve continuous flows of preforms/containers.

The disclosure, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1-18. (canceled)

19. A device for temporary storage of containers, which comprises at least one feeder conveyor of said containers and at least one unloading conveyor of said containers, and further comprising a storage unit comprising a plurality of accommodation bodies which extend substantially parallel to each other along a substantially vertical direction of extension and are each configured to accommodate a plurality of said containers stacked on top of each other with longitudinal axis of extension thereof arranged parallel to a direction of extension of a respective accommodation body of said plurality of accommodation bodies.

20. The device according to claim 19, further comprising movement means configured for movement on command of said containers along said direction of extension, said means for movement on command being configured to bring the containers arriving from said feeder conveyor from a first elevation to a second elevation along said direction of extension.

21. The device according to claim 20, wherein said means for movement on command are configured to act when placed under a bottom of the respective said containers during a transition from said first elevation to said second elevation.

22. The device according to claim 19, wherein said containers comprise containers that are already filled.

23. The device according to claim 20, further comprising locking means configured for temporary locking of said containers at said second elevation.

24. The device according to claim 20, wherein said accommodation bodies are arranged at a peripheral region of a carousel and rotate on command around an axis of said carousel, said axis of the carousel being arranged substantially parallel to said directions of extension.

25. The device according to claim 23, wherein said means for movement on command comprise a movement pan which is arranged below a respective accommodation body and is movable on command along a vertical direction to bring a respective container arriving from said feeder conveyor from said first elevation to said second elevation, arranged above said first elevation, said means for temporary locking being arranged substantially at said second elevation.

26. The device according to claim 23, wherein said means for temporary locking are functionally associated with actuation means adapted to allow transition thereof from an active condition, in which the means for temporary locking retain said container at said second elevation, to an inactive position, in which said means for temporary locking disengage from said container to allow unloading of the container from said storage unit.

27. The device according to claim 20, wherein the containers arranged at each accommodation body and arranged above the container at said second elevation are supported directly by the container that is arranged directly below.

28. The device according to claim 23, wherein said means for temporary locking are adapted to pass from said active condition to said inactive position in order to enable a transfer of said container from said first elevation to said second elevation.

29. The device according to claim 19, further comprising adjusting means configured for adjusting transverse dimensions of said accommodation bodies.

30. The device according to claim 19, wherein said accommodation bodies comprise a plurality of elongated elements which extend parallel to said direction of extension.

31. The device according to claim 30, wherein said means for adjusting the transverse dimensions of said accommodation bodies comprise means for a radial movement of said elongated elements.

32. The device according to claim 20, wherein said means for movement on command comprise, at each accommodation body, at least one elongated element which extends substantially parallel to said direction of extension and is associated with a plurality of supporting bodies which are spaced apart from each other along said direction of extension and are designed to define a resting surface for the bottom of a respective container, said means for movement on command being configured to move on command said supporting bodies along said direction of extension.

33. The device according to claim 32, wherein said elongated element is wound around at least one movement pulley which is kinematically connected to actuation means.

34. A system for processing containers, which comprises an apparatus for producing containers via blow-molding of preforms, further comprising, downstream of said apparatus for producing said containers, at least one device according to claim 19.

35. The system according to claim 34, further comprising, downstream of said apparatus for producing said containers, at least one apparatus for filling and capping said containers, said at least one device being arranged downstream of said filling and capping apparatus.

36. The system according to claim 34, further comprising an apparatus for labeling said containers, said device being arranged upstream of said labeling apparatus.
